(19) United States
(12) Patent Application Publication
(10) Pub. No.: US 2025/0338799 A1
(43) Pub. Date: Nov. 6, 2025

(54) Method For Carrying Out A Braking Operation Of A Knife Carrier Of A Cutting Apparatus, Assembly Configured To Carry Out Such A Method, Garden Tool Or Device Comprising Such An Assembly

(71) Applicant: Andreas Stihl AG & Co. KG, Waiblingen (DE)

(72) Inventors: Christian Sigle, Weinstadt (DE); Joscha Staub, Weinstadt (DE)

(73) Assignee: Andreas Stihl AG & Co. KG, Waiblingen (DE)

(21) Appl. No.: 19/196,147

(22) Filed: May 1, 2025

(30) Foreign Application Priority Data
May 3, 2024 (DE) 102024112541.1

(51) Int. Cl. A01G 3/053

(52) U.S. Cl. CPC A01G 3/053

(57) ABSTRACT

A method for carrying out a braking operation of a knife carrier of a cutting apparatus includes setting the knife carrier into a working movement by means of a drive unit and, in response to a command, carrying out a braking operation of at least the knife carrier at least as a function of at least one operating parameter of the drive unit in such a way that the knife carrier is brought to a standstill from the working movement in a predetermined rest position, wherein the at least one operating parameter is an operating parameter of a motor of the drive unit. An assembly is configured to carry out such a method. A garden tool, a device used in landscape maintenance or road maintenance depots and/or a device used in agriculture or forestry, may each have such an assembly.

### CROSS-REFERENCE TO RELATED APPLICATIONS

This application claims priority of German Patent Application No. 10 2024 112 541.1, filed May 3, 2024. The disclosure of this prior application is considered part of the disclosure of this application and is hereby incorporated by reference in its entirety.

### BRIEF DESCRIPTION

The present disclosure relates to a method for carrying out a braking operation of a knife carrier of a cutting apparatus. The present disclosure also relates to an assembly configured to carry out such a method. The present disclosure further relates to a garden tool, a device used in landscape maintenance or road maintenance depots and/or a device used in agriculture or forestry, each having such an assembly.

### BACKGROUND

Hedge trimmers comprise a cutting apparatus for trimming hedges, shrubs and the like. Typically, several knives are formed on two movable knife carriers arranged one above the other in such a cutting apparatus. If the two knife carriers together with their knives are moved against each other, two knives from different knife carriers work together in pairs and in part, thus functionally realizing a plurality of shears.

However, it has been found to be disadvantageous with previously known cutting apparatuses that cleaning the components of the cutting apparatus, in particular the knives, can be comparatively time-consuming. In addition, the knives can sometimes stick relatively easily due to remaining plant residues as well as residues of resin and other plant juices, which can increase the cleaning and maintenance effort. Similar observations have also been made with other garden tools and devices with previously known cutting apparatuses.

Thus, it is an object of the present disclosure to overcome the described disadvantages of the prior art and, in particular, to specify means by which cleaning and/or maintenance of cutting apparatuses of garden tools and other devices can be made simpler and thus more efficient and favorable.

### SUMMARY

The problem is solved by the disclosure according to a first aspect by proposing a method for carrying out a braking operation of at least a first knife carrier of a cutting apparatus, wherein the first knife carrier is set into a working movement by means of a drive unit and, in response to a command, a braking operation of at least the first knife carrier is carried out at least as a function of at least one operating parameter of the drive unit in such a way that the first knife carrier is brought to a standstill from the working movement in a predetermined rest position, wherein the at least one operating parameter is an operating parameter of a motor of the drive unit.

The disclosure is based on the surprising realization that conclusions can be drawn about the position of the first knife carrier and thus about the position of the knives carried by it based on the operating parameters of the drive unit. By consequently carrying out the braking operation while taking into account one or more operating parameters of the drive unit, it is possible to move to a predetermined rest position of the first knife carrier in a targeted manner. In this way, the knives arranged on the first knife carrier can also be brought to a standstill in a defined position, in which, for example, particularly good accessibility of the individual knives is achieved and thus easier cleaning of the knives can be made possible.

In this context, it has proven to be particularly advantageous that the operating parameter is usually provided by the drive unit anyway, in particular as an operating parameter signal can be decoupled from it. The operating parameter can then be evaluated in a particularly simple way and a result of this evaluation can be used very easily to carry out the braking operation. In doing so, particular, no additional sensors are required in particular. Thereby, costs and maintenance effort associated with electrical sensor components are reduced and reliability is increased.

Thereby, the proposed method can otherwise also be easily retrofitted and used in existing arrangements that comprise a cutting apparatus and associated drive unit. For example, the proposed method can be implemented very economically in existing arrangements by means of a software update of the components controlling the braking operation.

Carrying out the braking operation can comprise or represent control and/or regulation of the movement of at least the first knife carrier.

In particular, carrying out the braking operation comprises (i) a selection of a starting time for the braking operation, (ii) a selection of the duration of the braking operation and/or (iii) a selection of a time profile for the braking operation, in particular (a) by dividing the braking operation into a plurality of phases. (b) by selecting the manner of braking, in particular for each phase, and/or (c) the, in particular time-dependent, intensity of braking, in particular for each phase.

The working movement of the first knife carrier then advantageously ends with the start of the braking operation. The first knife carrier is advantageously set into the working movement by means of the drive unit until the start of the braking operation. During the braking operation, in particular with the start of the braking operation until the first knife carrier comes to a standstill, the first knife carrier carries out a braking movement that advantageously follows the working movement immediately in terms of time.

If this application states that the braking operation is carried out as a function of a variable, a result or something else, this is understood to mean, in particular, that the braking operation is carried out explicitly or implicitly as a function of the respective variable, the respective result or the respective something else, unless the context indicates otherwise.

For the purposes of this application, a knife carrier, such as the first knife carrier, is understood to mean an element, in particular a bar-shaped or disc-shaped element, on which one or more knives can be arranged or are arranged, in particular can be screwed on or are screwed on, or, are formed integrally. Advantageously, the thickness of the element, namely a dimension of the element proceeding perpendicular to a flat extent of the element, can be chosen to be small in comparison to a maximum dimension of the element within the flat extent of the element. For example, the thickness is then 30% of the maximum dimension or less than 30% of the maximum dimension, in particular 15% of the maximum dimension or less than 15% of the maximum dimension, in particular 5% of the maximum dimension or less than 5% of the maximum dimension. In particular, the thickness of the element is at least 0.001% of the maximum dimension of the element and/or at least 0.5 mm.

In one example, one or more knives are arranged on the first knife carrier or, in particular, are formed integrally with it. When this application states “knives of the first knife carrier”, this advantageously refers to such knives, regardless of the specific connection of the knives to the first knife carrier, unless the context indicates otherwise.

In one example, one or more projections are arranged or formed on the first knife carrier, of which at least some of the more projections each provide two knives the blades of which point in opposite directions in particular, wherein in particular a main direction of extension of each projection extends perpendicularly to a direction along which the working movement proceeds at least some of the time.

The braking operation can advantageously also be carried out as a function of further variables, results or something else, as will be explained in more detail later.

The operating parameter is advantageously a variable, in particular an electrical variable, of the drive unit or parts thereof, which is and/or can be detected by means of sensors and/or evaluated by means of electrical measuring technology.

The command in response to which the braking operation is carried out can be a control command. The command in response to which the braking operation is carried out can, for example, be received and/or identified. This can be done, for example, by receiving and/or evaluating a signal (for example via an interface) and identifying the command in response to receiving the signal and/or as a result of the evaluation. In particular, the command for this can be suitably encoded in the signal (and thus be advantageously accessible to evaluation) and/or suitably represented by the signal.

Alternatively or additionally, it can also be intended that the operating parameter of the motor of the drive unit is, in particular, a motor speed, a motor angle, a motor current and/or a motor torque, such as a motor torque, in each case of the motor.

In particular, the braking operation is carried out as a function of several of the aforementioned operating parameters of the motor.

The drive unit can comprise the motor. The first knife carrier can be in operative connection with the motor (advantageously, the motor is coupled directly or indirectly to the first knife carrier), in particular in such a way that an actuation of the motor at least partially controls and/or causes a movement of the first knife carrier.

Alternatively or additionally, it can also be intended that the braking operation is carried out at least partially as a function of an operating parameter signal, in particular as a function of an evaluation of the operating parameter signal.

The operating parameter signal can, for example, be a control unit signal of a control unit of the motor and/or represent time-dependent values of the operating parameter.

Advantageously, the operating parameter signal, in particular in the form of a control unit signal of the control unit of the motor, is obtained, in particular received, for example from the control unit, and/or evaluated. The braking operation is then advantageously carried out at least partially as a function of a result of the evaluation.

For example, the operating parameter signal can comprise a time-dependent, periodic and/or sinusoidal signal profile. The operating parameter signal is advantageously a discrete-time signal.

The control unit of the motor can, for example, be a motor control of the motor.

Alternatively or additionally, it can also be intended that the operating parameter signal is preprocessed, in particular by carrying out at least one smoothing, one filtering and/or one normalization of the operating parameter signal.

In particular, the operating parameter signal can be preprocessed in terms of signal technology.

Alternatively or additionally, it can also be intended that, in the in particular preprocessed operating parameter signal, one or more features, such as one or more characteristic curves of the operating parameter signal, one or more extreme values and/or zero crossings in the course of the operating parameter signal and/or one or more points in time, in particular at which an extreme value and/or zero crossing occurs in the operating parameter signal course, and the braking operation is carried out at least partially as a function of the identified features.

Further alternatively or additionally, it can be intended that, in the in particular preprocessed operating parameter signal, one or more features, such as one or more characteristic curves of the operating parameter signal, one or more extreme values and/or zero crossings in the course of the operating parameter signal and/or one or more points in time, in particular at which an extreme value and/or zero crossing occurs in the operating parameter signal course, and the braking operation is carried out at least partially as a function of at least one of the identified features.

Further alternatively or additionally, it can be intended that, in the in particular preprocessed operating parameter signal, one or more features, such as one or more characteristic curves of the operating parameter signal, one or more extreme values and/or zero crossings in the course of the operating parameter signal and/or one or more points in time, in particular at which an extreme value and/or zero crossing occurs in the operating parameter signal course, and the braking operation is carried out at least partially as a function of several identified features.

Further alternatively or additionally, it can be intended that, in the in particular preprocessed operating parameter signal, one or more features, such as one or more characteristic curves of the operating parameter signal, one or more extreme values and/or zero crossings in the course of the operating parameter signal and/or one or more points in time, in particular at which an extreme value and/or zero crossing occurs in the operating parameter signal course, and the braking operation is carried out at least partially as a function of all identified features.

In doing so, the features can, for example, be identified constantly (at least during the working movement of the first knife carrier) or only within a certain time window. In particular, a starting time at which the identification of the features is started, in particular for a defined period of time, is determined at least partially based on the point in time at which the command to carry out the braking operation is triggered and/or identified.

In one example, the features are identified, in particular at least temporarily or permanently, at least while the first knife carrier is carrying out the working movement. This allows for a particularly simple implementation, since no additional signals and events have to be taken into account.

In another example, the features are defined or determined from a specific starting time, which is defined in particular based on a time at which the command for carrying out the braking operation is triggered and/or identified, and/or are identified during a specific period. For this purpose, the starting time and/or the period are determined accordingly. Thus, resources for the evaluation of the operating parameter signal can be saved, because the identification of features is limited to a certain time window.

In any case, it can be advantageous to identify only a single feature in the operating parameter signal (for example, the occurrence of a single zero crossing or extreme value in the signal course). This single feature can already be sufficient to carry out the braking operation as a function of it and can therefore be very efficient. However, it can also be advantageous to identify several features, for example several similar features, such as several (in particular consecutive) extreme values and/or zero crossings in the signal course. Then the braking operation can be carried out taking into account these several features, which can enable a more precise control of the braking operation. For example, several identified features and/or their temporal occurrence can be compared with each other and the braking operation can be carried out as a function of a result of the comparison.

In particular, the braking operation is carried out at least partially as a function of at least the last feature identified before a specific point in time (advantageously only the last feature identified before the specific point in time or several features identified before the specific point in time) and/or at least the first feature identified after the specific point in time (advantageously only the first feature identified after the specific point in time or a plurality of features identified after the specific point in time), the specific point in time being a point in time at which the command for carrying out the braking operation is triggered and/or identified and/or determined based on this point in time.

If extreme values are identified as features in the course of the operating parameter signal, they can be, in particular, local maxima and/or minima of the signal course.

Alternatively, or additionally, it can also be intended that at least one identified feature is assigned a defined position of the first knife carrier.

Further alternatively or additionally, a defined position of the first knife carrier is assigned to several, in particular all, identified features. For example, identical defined positions can also be partially assigned to the identified features.

For example, a maximum of the operating parameter signal can be assigned a position representing a reversal point of the first knife carrier during its (in particular periodic and/or oscillating) working movement and/or a minimum of the operating parameter signal course is assigned a position representing a center position of the first knife carrier during its (in particular periodic and/or oscillating) working movement, in particular between two immediately successive reversal points during its working movement, or vice versa.

The following table indicates a position of the first knife carrier that can advantageously be assigned to the feature for each combination of operating parameter and feature for a selection of possible operating parameters (motor current, motor torque, motor speed) and identifiable features (maximum, minimum) in the signal course of the respective operating parameter.

| | Motor current | Motor torque | Motor speed |
|---|---|---|---|
| Maximum | Reversal point | Reversal point | Center position |
| | | | (between two |
| | | | successive |
| | | | reversal points) |
| Minimum | Center position | Center position | Reversal point |
| | (between two | (between two | |
| | successive | successive | |
| | reversal points) | reversal points) | |

In examples, other assignments are also possible, in particular, although the aforementioned ones have proven to be advantageous.

Alternatively or additionally, it can also be intended that the braking operation is carried out as a multi-stage braking operation, in particular at least a two-stage braking operation, the braking operation including a recuperative phase and/or a phase, in particular a phase which follows it in time and, in particular, directly follows it, during which an electrically controlled braking operation is carried out.

In the recuperative phase, which advantageously represents one stage of the multi-stage braking operation, kinetic energy of the cutting apparatus can be converted into electrical energy (and advantageously stored in an energy storage, such as a rechargeable battery) in order to thus brake at least the first knife carrier.

Using the electrically controlled braking, which advantageously represents one stage of the multi-stage braking operation, the cutting apparatus, in particular the first knife carrier, can be brought to an abrupt, i. e. comparatively fast, standstill, especially at low speeds of the motor. In order to carry out the electrical braking, for example, the motor phases can be short-circuited.

In one example, the multi-stage braking operation includes, in addition to the recuperative phase and/or the phase during which an electrically controlled braking operation is carried out, a friction phase in which the braking is carried out purely by friction. For example, the recuperative phase follows the friction phase, in particular chronologically, in particular immediately thereafter. Alternatively, the phase during which an electrically controlled braking operation is carried out follows the friction phase, in particular chronologically, in particular immediately thereafter. Thus, in addition to two-stage braking operations, at least three-stage braking operations are also advantageously possible.

Alternatively or additionally, it can also be intended that the braking operation of the first knife carrier is carried out as a function of at least one configuration parameter of the drive unit, such as a transmission ratio of a gearbox of the drive unit.

Such configuration parameters can be used to advantageously take into account mechanical, structural and/or other static parameters of the drive unit during the braking operation.

For example, the transmission ratio of the gearbox of the drive unit represents a gear reduction.

Alternatively or additionally, it can also be intended that at least one positional position of the motor shaft of the motor is detected and the braking operation of the first knife carrier is carried out as a function of the at least one detected positional position.

Further alternatively or additionally, it can be intended that a plurality of positional positions of the motor shaft of the motor are detected and the braking operation of the first knife carrier is carried out as a function of at least one of the detected positional positions.

In this application, a positional position (of the motor shaft) of the motor is understood to mean a, in particular relative or absolute, rotational position of the motor shaft of the motor. If the positional position presents a relative rotational position, the positional position can, for example, always have a value within a range A=[0 . . . 2π] (i.e. “modulo two pi”) during a continuous rotational movement of the motor shaft. If the positional position presents an absolute rotational position, the positional position can comprise a continuously increasing value during a continuous rotational movement of the motor shaft. If the positional position presents an absolute rotational position, the number of revolutions of the motor shaft can consequently be determined since a starting time.

The positional positions can advantageously be detected by means of a position encoder, such as a rotary encoder, such as an incremental encoder or an absolute encoder. Alternatively or additionally, the detection of the positional positions can also comprise an evaluation of at least the current and/or voltage values applied to the motor.

The positional positions can advantageously be detected in steps (angles of rotation) of at least 0.1° and/or at most 360°, for example, in steps of 1°, 5°, 10°, 15°, 45°, 90° or 180°.

The positional positions can be provided as an, in particular discrete-time, positional position signal. The positional position signal can then be reliably evaluated.

Alternatively or additionally, it can also be intended that a relationship between a time course of the positional position of the motor shaft of the motor on the one hand and a time course of the operating parameter signal on the other hand is determined or predetermined and the braking operation is carried out as a function of the determined or predetermined relationship.

The relationship can be used to advantageously determine when the features identified in the operating parameter signal occur in relation to the positional position of the motor. The relationship can also be used to advantageously determine at which later positional positions of the motor and/or at which later points in time similar features to the identified feature or features occur in the operating parameter signal.

Alternatively or additionally, based on the relationship, at least one specific feature among the identified features is assigned to one or more positional positions, which serves or serve advantageously as a time reference for the occurrence of the specific feature. For example, the occurrence of a specific feature (such as a maximum in the course of the operating parameter signal) can be limited to a period between two positional positions of the motor (such as zero crossings of the positional position signal).

A positional position change of the motor shaft, the number of zero crossings of the positional position signal and/or the time interval between two identified features is advantageously known. For example, this can be determined at least in part using the configuration parameter described above, in particular as a transmission ratio.

If the positional position change, the number of zero crossings and/or the time interval between two features is then known and the number of zero crossings is known that is needed to carry out the braking operation, the braking operation can thus advantageously be started in good time after the occurrence of the first feature and/or before the occurrence of the second feature, in each case in the operating parameter signal. This will be discussed in more detail below.

Alternatively or additionally, it may also be intended that an initial assignment is defined that describes or makes a positional position change of the motor shaft of the motor determinable, in particular a number of revolutions of the motor shaft of the motor, that is necessary to move the first knife carrier during the working movement from a specific position, in particular a position in which the first knife carrier is located in a reversal point and/or in a center position, in particular between two reversal points, to move it again to the specific position during the working movement.

For example, the first assignment can describe or make it determinable that the first knife carrier is located in a reversal point every X revolutions of the motor shaft.

In the case of a periodic working movement, it is also determinable from this after how many revolutions of the motor shaft the first knife carrier is again at the same reversal point.

Alternatively or additionally, it may also be intended that a second assignment is defined which describes or makes a positional position change of the motor shaft of the motor determinable, in particular a number of revolutions of the motor shaft of the motor, which is necessary to bring the first knife carrier to a standstill during the braking operation, starting from the working movement.

For example, the second assignment can describe or make it determinable that the first knife carrier is at a standstill after Y revolutions of the motor shaft from the working movement.

For example, the second assignment will or can be determined at least partially experimentally.

For example, the second assignment will or can be determined at least partially based on a base load measurement during the operation of the cutting apparatus. In particular, the second assignment can be based on or correspond to a characteristic curve, by means of which a mean braking duration can be or is assignable to various base loads. In this sense, a measure of friction based on a base load measurement during the operation of the cutting apparatus can be advantageously derived. A relatively high base load can then be indicative of relatively high friction values, so that in this case the braking duration is shorter than when there is a relatively low base load, which may be indicative of relatively low friction values.

If it is therefore known after which remaining positional position change of the motor shaft the rest position is reached, the point in time for starting the braking operation can be determined accordingly based on the second assignment and the braking operation can be started accordingly.

Alternatively or additionally, it can also be intended that a third assignment is defined which describes or makes a positional position change of the motor shaft of the motor determinable, in particular a number of revolutions of the motor shaft of the motor, that is necessary to move the first knife carrier during the working movement from its position at the point in time of occurrence of a specific feature in the operating parameter signal to a position that corresponds to the rest position.

For example, the third assignment can describe or make it determinable that Z revolutions of the motor shaft elapse between the occurrence of the specific feature and reaching the rest position (during the working movement), or that (Z-Y) revolutions of the motor shaft will elapse before the braking operation is started.

Alternatively or additionally, it may also be intended that the braking operation is started with a time delay after the occurrence of at least one specific feature among the features identified in the course of the operating parameter signal, the time delay being selected at least partially as a function of (i) the determined relationship, (ii) the first assignment, (iii) the second assignment and/or (iv) the third assignment, in particular selected such that the motor shaft of the motor performs a defined change in the positional position during the time delay.

Alternatively or additionally, it may also be intended that a current and/or future position of the first knife carrier is determined at least partially based on the, in particular preprocessed. operating parameter signal and/or at least one, in particular several, of the features identified therein, the positional position of the motor shaft of the motor, the determined relationship, the first assignment, the second assignment and/or the third assignment, and the braking operation is carried out at least partially as a function of the determined current and/or future position.

Further alternatively or additionally, it may be intended that a current and/or future position of the first knife carrier is determined based on the, in particular preprocessed. operating parameter signal and/or several, in particular all of the features identified therein, the positional position of the motor shaft of the motor, the determined relationship, the first assignment, the second assignment and/or the third assignment, and the braking operation is carried out at least partially as a function of the determined current and/or future position.

The above-mentioned current and/or future position of the first knife carrier can be a relative position of the first knife carrier in relation to another element (such as a counter-element, which will be described in detail below), in particular the cutting apparatus.

Advantageously, the above-described assignment between an identified feature and a defined position of the first knife carrier is included to determine the current and/or future position.

Alternatively or additionally, it may also be intended that a future point in time for initiating the braking operation and/or at least one phase thereof and/or a course of the braking operation and/or at least one phase thereof is at least partially determined based on (i) the determined current and/or future position of the first knife carrier, (ii) the positional position of the motor, the determined relationship, the first assignment, the second assignment and/or the third assignment, (iii) the, in particular preprocessed, operating parameter signal and/or the features identified therein, (iv) a predetermined or determined deceleration characteristic of the drive unit, the cutting apparatus and/or the first knife carrier and/or (v) an extrapolation of the operating parameter signal and/or the current position, and in particular the braking operation and/or at least one phase of the braking operation is carried out, in particular initiated, at least partially as a function of the determined future point in time and/or the determined profile.

By including the deceleration characteristic when determining the future point in time and/or the course of the braking operation, cutting apparatus-specific, drive unit-specific and/or time-dependent influences, such as a change in the wear state of the cutting apparatus and its parts and/or the drive unit and its parts, can also be taken into account and the braking operation can be carried out precisely.

The deceleration characteristic can be a deceleration characteristic of the drive unit and the cutting apparatus and thus a deceleration characteristic of the arrangement formed by the drive unit and the cutting apparatus.

The deceleration characteristic can, for example, be predetermined and/or be a deceleration characteristic that has been determined once. Such a deceleration characteristic can also be used advantageously for several arrangements (or individual drive units and/or cutting apparatuses) of the same design. In this case, for example, it can be assumed that the friction over several arrangements (or individual drive units and/or cutting apparatuses) is approximately the same. In addition, it can be assumed that the friction does not change over time or does not change significantly. Such approximations are based on a rather simple approach, but surprisingly they already lead to good results.

A once determined deceleration characteristic can be stored in a memory. Before the braking operation is carried out, the deceleration characteristic can then be retrieved from the memory and taken into account as described for carrying out the braking operation.

A once determined deceleration characteristic can be predetermined by the manufacturer, which is particularly advantageous.

An example of a once determined and/or predetermined deceleration characteristic for such an arrangement is the relationship that, starting from a residual speed X (for example 1,000 rpm) at the drive unit motor, the first knife carrier comes to a standstill as a result of braking power and friction Y1 (for example 25) motor revolutions later after the braking operation has started.

In practice, friction differs from one arrangement to the other and, for a specific arrangement, is usually also dependent on the time that has elapsed since the last maintenance, operating temperature, wear and lubrication of the arrangement. However, if the differences are small, they can advantageously be ignored.

In one example, the deceleration characteristic is therefore determined at least once and/or repeatedly, in particular for the respective arrangement, the respective drive unit and/or the respective cutting apparatus. For example, a deceleration characteristic can be redetermined at time intervals that can be defined by a predetermined service interval. In particular, the deceleration characteristic is redetermined while carrying out a braking operation, in particular in an automated manner. Thereby, this can advantageously be at least partially automated and thus ideally carried out without the intervention of a user.

Thus, friction occurring in the respective arrangement can advantageously be taken into account. For this purpose, a temperature of the arrangement, a wear state of the arrangement and/or a lubrication state of the arrangement can be taken into account.

The deceleration characteristic can be determined at least based on measurement data for one or more parameters and/or for one or more states of the arrangement (or the drive unit and/or the cutting apparatus), in particular of the motor.

In one example, the deceleration characteristic is determined by forming load spectra during operation of the arrangement, in particular during operation of the motor, and evaluating the idle power drawn, in particular from the motor. Since the no-load power is influenced by friction (more friction leads to a higher no-load power), this parameter has proven to be a particularly advantageous measured variable. With higher friction and thus higher idle power, the first knife carrier comes to a standstill within a shorter time than with lower friction.

Therefore, as a function of the idle power determined, a new deceleration characteristic can be determined and/or an existing deceleration characteristic can be adjusted. In the example described above, the deceleration characteristic could then be adjusted when identifying higher friction. For example, the new deceleration characteristic could be intended so that, starting from a residual speed X (for example the above-mentioned 1,000 rpm) at the drive unit motor, the first knife carrier comes to a standstill as a result of braking power and friction Y2<Y1 (for example, then only Y2=20, instead of the previous Y1=25) motor revolutions later after the braking operation has started.

The determined course of the braking operation can, for example, comprise information on the temporal length of at least one phase of the braking operation and/or information on a braking force (for example, a deceleration in m/s2) or its course during at least one phase of the braking operation.

Alternatively or additionally, it can also be intended that the cutting apparatus comprises a counter-element to the first knife carrier, such as a second knife carrier or a cutting edge carrier.

The counter-element, in particular the second knife carrier and/or the cutting edge carrier, can be stationary or movable, for example.

In one example, the cutting apparatus comprises the first knife carrier and the counter-element, wherein the first knife carrier and the counter-element are arranged one above the other (in particular along a direction perpendicular to a direction of working movement) and/or are movable relative to one another.

In one example, the cutting apparatus comprises the first knife carrier and the second knife carrier (as a counter-element). This arrangement is also referred to as a double knife carrier and, in particular with regard to the respective knives, is also known in a hedge trimmer under the term sword.

In one example, one or more knives are arranged on the second knife carrier or, in particular, are formed integrally with it. When this application states “knives of the second knife carrier”, this advantageously refers to such knives, regardless of the specific connection of the knives to the second knife carrier, unless the context indicates otherwise.

In one example, one or more projections are arranged or formed on the second knife carrier, of which at least some of the more projections each provide two knives the blades of which point in opposite directions in particular, wherein in particular a main direction of extension of the projections extends perpendicularly to a direction along which the working movement proceeds at least some of the time.

The second knife carrier is advantageously designed to be identical to the first knife carrier, in particular including the knives each arranged or formed on it. The knives on the first and second knife carriers are advantageously arranged or formed in the same way. In this way, the two knife carriers, in particular including the knives each arranged or formed on them, can advantageously be brought into alignment with one another.

In particular, the first knife carrier is moved along the second knife carrier (for example, below or above the second knife carrier), at least during the working movement.

In one example, the cutting apparatus comprises the first knife carrier and the cutting edge carrier (as a counter-element).

In one example, one or more cutting edges are arranged on the cutting edge carrier or, in particular, are formed integrally with it. When this application states “cutting edges of the cutting edge carrier”, this advantageously refers to such cutting edges, regardless of the specific connection of the cutting edges to the cutting edge carrier, unless the context indicates otherwise.

One or more or all cutting edges can comprise blades (and thus form knives). However, one or more or all cutting edges can also be blunt (and thus bladeless).

In one example, fingers are arranged on the cutting edge carrier and/or, in particular, are formed integrally with it. The fingers represent cutting edges. This design is also referred to as a finger mower.

The first knife carrier is moved, at least during the working movement, along the cutting edges (like fingers) (for example, below or above the cutting edges) or through the cutting edges (like fingers).

Alternatively or additionally, it can also be intended that the cutting apparatus (i) is designed as a double blade carrier, in particular as a sword, or in the manner of a finger mower, (ii) is part of a garden tool, a device used in landscape maintenance or in road maintenance depots or a device used in agriculture or forestry and/or (iii) (a) for processing, in particular pruning, of plants, in particular a hedge, a shrub, a bush and/or plants with a firm stem, (b) for mowing grass, grain and/or fruit and/or (c) for harvesting plants, in particular grass, grain, com and/or rape.

The cutting apparatus can, for example, be part of a hedge trimmer (as a garden tool) or of rotary shears.

The sword can, for example, be part of a hedge trimmer.

The double knife carrier can be formed at least partially by the first knife carrier and the second knife carrier.

The finger mower can be formed at least partially by the first knife carrier and the cutting edge carrier.

Alternatively or additionally, it can also be intended that a movement of the first knife carrier takes place relative to the counter-element and/or the knives arranged or formed on the first knife carrier and the cutting edges and/or knives arranged or formed on the counter-element interact when the processing and/or harvesting of plants is carried out.

In this respect, for example, either the first knife carrier or the counter-element can be stationary. For example, either the first knife carrier or the counter-element or the first knife carrier and the counter-element can movable.

One or more scissor-like elements are formed by the interaction of the knives arranged or formed on the first knife carrier and the (in particular blunt and/or sharp) cutting edges and/or knives arranged or formed on the counter-element. These can then, for example, prune the plants or plant parts when processing and/or harvesting plants.

Alternatively or additionally, it can also be intended that a movement of the counter-element is force-coupled to a movement of the first knife carrier.

So when the first knife carrier moves, the counter-element also moves, in particular in a predictable manner, and vice versa. A forced coupling of the movement can be realized, for example, by a mechanical coupling of the first knife carrier and the counter-element via a common drive wheel.

The advantage of a forced coupling is that the rest position of the first knife carrier can also be used to specify or predetermine the rest position of the counter-element.

Alternatively or additionally, it can also be intended that a movement of the first knife carrier takes place with an offset phase, in particular out of phase, to a movement of the counter-element.

This can be realized, for example, by means of a forced coupling as described above.

Alternatively or additionally, it can also be intended that the predetermined rest position of the first knife carrier is selected from at least two possible rest positions of the first knife carrier, in particular by a user selection.

Alternatively or additionally, it can also be intended that the rest positions of the first knife carrier are defined relative to rest positions of the counter-element.

Alternatively or additionally, it can also be intended that the working movement is a linear, rotating and/or oscillating movement and/or that the carrying out of the braking operation comprises or constitutes a control and/or regulation of the braking operation.

In one example, the working movement is a linear and oscillating movement.

In one example, the working movement is a rotating and oscillating movement.

In particular, an oscillating movement is understood to mean a “back and forth” movement. Examples of such a “back and forth” movement are a linear “back and forth” movement (back and forth) and a rotating “back and forth” movement (left and right around an axis of rotation). In particular, such an oscillating rotational movement between two reversal points can cover an angular range of less than 360°, for example, an oscillating rotational movement between two reversal points can cover an angular range of between 5° and 45°. However, such an oscillating rotational movement can also cover an angular range of 360° or more than 360° between two reversal points, for example an oscillating rotational movement can cover an angular range of between 540° and 720° between two reversal points (thus making about two revolutions in one direction, then again two revolutions in the other direction, and so on).

During the working movement, the first knife carrier can also be in a state of rest for a time. This is the case, for example, when the first knife carrier is at a reversal point in an oscillating working movement. As long as the first knife carrier is brought into a (short-term) state of rest as part of the working movement, the first knife carrier is not brought to a standstill in the sense of a braking operation considered in this application, and accordingly no braking operation as considered in the context of this application takes place in this context.

Alternatively or additionally, it can also be intended that, in particular when looking at the cutting apparatus along a defined line of sight from below or from above, in a first possible rest position of the at least two possible rest positions of the first knife carrier (i) each of a plurality, in particular all, knives of the first knife carrier are each in a position in which they are at least partially or completely covered by a structure of the counter-element, in particular in the form of knives of the second knife carrier or cutting edge elements such as fingers, of the cutting edge carrier, at least in some areas or completely covered, and/or (ii) the knives of the first knife carrier are in a position in which the knives of the first knife carrier, in particular when looking at the cutting apparatus along the defined line of vision from below or from above, are located one above the other with the knives of the second knife carrier.

The first possible rest position is in particular a maintenance position. Since the knives of the first knife carrier are at least partially covered by the partner structures, a maintenance operation, such as sharpening the knives, can be more easy.

The structures of the counter-element defining the partner structures can therefore be the knives arranged on or formed by the counter-element (then in the form of the second knife carrier).

Alternatively or additionally, it can also be intended that, in particular when looking at the cutting apparatus along the defined viewing direction from below or from above, in a second possible rest position of the at least two possible rest positions of the first knife carrier (i) each of a plurality, in particular all, of the knives of the first knife carrier is in each case in a position in which it (a) is offset with respect to its respective partner structure, in particular along a direction parallel to the working movement, and/or (b) is covered by its respective partner structure to a lesser extent than in the first rest position or is/are no longer covered by its respective partner structure, and in particular is not covered by one or more of the other partner structures, and/or (ii) the knives of the first knife carrier are in a position (a) in which the knives of the first knife carrier, in particular when looking at the cutting apparatus along the defined line of sight from below or from above, are offset with respect to the knives of the second knife carrier and/or (b) in which the knives of the first knife carrier are accessible for a grinding and/or cleaning operation and/or in which the knives of the two knife carriers do not stick.

The second possible rest position is advantageously a storage position. Since the knives of the first knife carrier are at least partially offset in relation to the partner structures, the elements of the cutting apparatus are less likely to stick together. In addition, the knives are easily accessible for cleaning. The same applies to the knives of the second knife carrier as a counter-element.

The object is solved by the disclosure according to a second aspect in that an assembly. in particular for a garden tool, a device used in landscape maintenance or in road maintenance depots or for a device used in agriculture or forestry, having a cutting apparatus and a drive unit, which is or can be operatively connected to at least a first knife carrier of the cutting apparatus and by means of which the first knife carrier can be set in a working movement, the assembly having a control apparatus which is or can be operatively connected to at least the drive unit, the assembly being configured to carry out a method according to the first aspect of the disclosure.

All the advantages described in relation to the method according to the first aspect of the disclosure also apply accordingly to the assembly according to the second aspect of the disclosure. Therefore, reference can be made at this point to the previous explanations.

The features described in relation to the method according to the first aspect of the disclosure can also be intended accordingly for the assembly, individually and in any combination, unless the context indicates otherwise.

In particular, the physical and functional designs of the individual parts described in connection with the method according to the first aspect of the disclosure, as well as the structural and functional relationships between the individual parts (such as the drive unit and the cutting apparatus and their parts, such as in particular the first and second knife carrier and their knives) can also be intended in the assembly, individually and in any combination, unless the context indicates otherwise.

In particular, the check apparatus is configured to carry out the method according to the first aspect of the disclosure. For this purpose, the check apparatus can interact with the other components of the assembly, in particular sending and receiving data. For example, the check apparatus can be configured to receive the command to initiate the braking operation, the operating parameter signal and/or the positional position signal, to process, evaluate and/or analyze it and/or to send a check command, in each case as described in the present application, in particular in connection with the method according to the first aspect of the disclosure.

The check apparatus can be implemented, for example., in software, in hardware or as a combination of both. The check apparatus can be a device for processing data. Alternatively or additionally, the check apparatus can comprise a memory, a processor, a receiving apparatus, a transmitting apparatus or any combination thereof. Alternatively or additionally, the check apparatus can provide and/or make available and/or comprise everything that it comprises, in particular all the necessary resources, for example in the form of software and/or hardware resources.

The check apparatus advantageously comprises interfaces for receiving the respective signals, such as the command for initiating the braking operation, the operating parameter signal and/or the positional position signal, and/or means for processing, evaluating and/or analyzing the respective signals.

The check apparatus advantageously comprises interfaces for sending a check command to the drive unit, in particular to the motor or to the motor control. The check command can advantageously be used to regulate and/or control the drive unit, and in particular to carry out the braking operation.

The check apparatus can advantageously be formed as part of the control unit of the motor of the drive unit or comprise the control unit.

Optionally, the check apparatus can also be operatively connected or connectable to the cutting apparatus.

The object is solved by the disclosure according to a third aspect in that a garden tool, a device used in landscape gardening or in road maintenance depots and/or a device used in agriculture or forestry, each comprising an assembly according to the second aspect of the disclosure, wherein (i) the garden tool or the device is operable by means of a rechargeable battery and/or (ii) the garden tool or the device is formed as a hedge trimmer or as a rotary trimmer.

All the advantages described in relation to the method according to the first aspect of the disclosure and/or in relation to the assembly according to the second aspect of the disclosure also apply accordingly to the gardening tool and the devices according to the third aspect of the disclosure. Therefore, reference can be made at this point to the previous explanations.

### BRIEF DESCRIPTION OF THE DRAWINGS

Further features and advantages of the disclosure will become apparent from the following description, in which examples of the disclosure are explained using schematic drawings.

Here:

FIG. 1 shows a schematic representation of an assembly according to the second aspect of the disclosure, comprising a cutting apparatus and a drive unit;

FIG. 2a shows a schematic representation of the cutting apparatus of FIG. 1 in a first configuration during an working movement;

FIG. 2b shows a schematic representation of the cutting apparatus of FIG. 1 in a second configuration during the working movement;

FIG. 2c shows a schematic representation of the cutting apparatus of FIG. 1 in a third configuration during the working movement;

FIG. 3a shows a diagram with a schematic course of an operating parameter signal of a motor of the drive unit;

FIG. 3b shows a diagram with a schematic course of a preprocessed version of the operating parameter signal of FIG. 3a;

FIG. 3c shows a diagram with a schematic course of a signal representing the points in time at which identified features occur in the signal course of FIG. 3b;

FIG. 3d shows a diagram with a correlation between a course of the operating parameter signal and a course of the positional position of the motor of the drive unit; and

FIG. 4 shows a flow chart of a method according to the first aspect of the disclosure.

### DETAILED DESCRIPTION

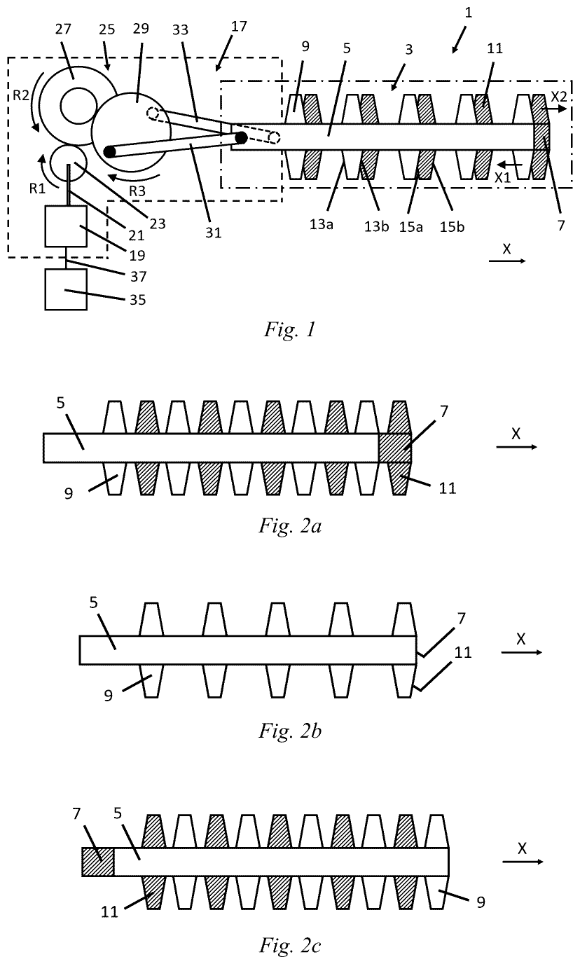

FIG. 1 shows a schematic representation of an assembly 1 according to the second aspect of the disclosure.

The assembly 1 comprises a cutting apparatus 3 with a first knife carrier 5 and a counter-element, presently in the form of a second knife carrier 7. In FIG. 1, the components of the cutting apparatus 3 depicted there are highlighted by a dashed common framing. The first knife carrier 5 is intended along the viewing direction selected in FIG. 1 from above onto the cutting apparatus 3 above the second knife carrier 7.

Several knives 9 are formed integrally with the first knife carrier 5. Likewise, several knives 11 are also formed integrally with the second knife carrier 7. In FIG. 1, for the sake of clarity, only one knife of each knife carrier 5, 7 has a reference symbol. Blades 13a and 13b and 15a and 15b are formed on two sides of the knives 9 and 11 of the first knife carrier 5 and the second knife carrier 7, respectively.

The second knife carrier 7 and its knives 11 are hatched in FIG. 1, where part of the second knife carrier 7 is covered by the first knife carrier 5 and parts of the knives 11 are also covered by the knives 9.

The two knife carriers 5 and 7 are intended in the cutting apparatus 3 so that they can be moved relative to one another. This allows the knives 9 and 11 of the first and second knife carriers 5, 7 to be moved past each other. Due to the identical structure, the two knife carriers 5, 7, including their knives 9, 11, can be brought into alignment.

By means of a drive unit 17 of the assembly 1, the first knife carrier 5 and the second knife carrier 7 can each be set into a linear, oscillating working movement. This means that each of the two knife carriers 5 and 7 can be moved cyclically in parallel and anti-parallel to direction X and thus performs a periodic “back and forth” movement during operation. In FIG. 1, the components of the drive unit 17 depicted there are highlighted by a dashed common framing.

If the two knife carriers 5 and 7 move against each other and their knives 9 and 11 also move against each other during the working movement, two knives from different knife carriers 5, 7 work together in pairs and in part, thus functionally realizing a plurality of shears. Thus, for example, it is possible to process, in particular to prune, plants, in particular a hedge, a bush, a shrub and/or plants with firm stems.

The drive unit 17 comprises a motor 19 with a motor shaft 21 that can rotate about an axis of rotation. The motor shaft 21 is coupled to a first gear wheel 23 of a gear mechanism 25 of the drive unit 17, so that the first gear wheel 23 can be set in a rotational movement along a direction R1 by a rotational movement of the motor shaft 21. The rotational movement of the first gear wheel 23 in the direction R1 causes a second gear wheel 27 of the gear mechanism 25, coupled to the first gear wheel 23, to be set in a rotational movement along a direction R2, and thus causes a third gear wheel 29 of the gear mechanism 25, coupled to the second gear wheel 27, to be set in a rotational movement along a direction R3. The fact that the motor shaft 21 in FIG. 1 is not perpendicular to the plane of the illustration is due to the schematic nature of the figure.

The third gear wheel 29 is coupled by a first coupling means 31 (which engages with it on the side of the third gear wheel 29 facing the observer in FIG. 1) to the first knife carrier 5 and by a second coupling means 33 (which engages with it on the side of the third gear wheel 29 facing away from the observer in FIG. 1) to the second knife carrier 7, each in a movable manner.

If the third gear wheel 29 is turned further along the direction R3, starting from the position shown in FIG. 1, the first knife carrier 5 is moved along the negative X-direction (direction X1) in FIG. 1 to the left and the second knife carrier 7 is moved along the positive X-direction (direction X2) in FIG. 1 to the right.

By means of the coupling means 31, 33 and due to their interaction with the third gear wheel 29 and the knife carriers 5, 7, a rotational movement of the third gear wheel 29 can be used to set each of the two knife carriers 5, 7 in a linear, oscillating movement in such a way that the movements of the two knife carriers 5, 7 are in opposite phases (i. e. a phase offset of 180°) to each other. So if the first knife carrier 5 is at the left reversal point (i. e. has moved as far as possible in the negative X direction), the second knife carrier 7 is at the right reversal point (i. e. has moved as far as possible in the positive X direction) and vice versa.

Since both knife carriers 5, 7 are coupled to the same third gear wheel 29 via the coupling means 31, 33 as described, the second knife carrier 7 performs a movement that is positively coupled to the movement of the first knife carrier 5. If the position of the first knife carrier 5 is fixed, the position of the second knife carrier 7 is also fixed.

FIGS. 2a to 2c show schematic representations of the cutting apparatus 3 of FIG. 1 in which the two knife carriers 5 and 7 each assume different positions relative to each other as they move relative to each other. The viewing direction continues to be from above onto the cutting apparatus 3.

During a complete movement cycle (in which the third gear wheel 29 makes a complete revolution), at a first point in time (at which the third gear wheel 29 has a first rotational position), the first knife carrier 5 is maximally deflected to the left and thus at its left reversal point, and the second knife carrier 7 is maximally deflected to the right and thus at its right reversal point. The configuration is shown in FIG. 2a.

At a later second point in time (at which the third gear wheel 29 has a second rotational position), the first knife carrier 5 was moved to the right and the second knife carrier 7 was moved to the left, and both knife carriers are in alignment with each other. In fact, each of the two knife carriers 5, 7 is in a center position, which is centered between the two reversal points. The configuration is shown in FIG. 2b. Since the second knife carrier 7, including its knife 11, is completely covered by the first knife carrier 5 and its knife 9, the second knife carrier 7 and its knife 11 are not visible in FIG. 2b.

At a later third point in time (at which the third gear wheel 29 has a third rotational position), the first knife carrier 5 in FIG. 2a has been moved further to the right up to its right reversal point and the second knife carrier 7 has been moved further to the left up to its left reversal point. The configuration is shown in FIG. 2c.

In the second half of the (one) movement cycle, the configuration depicted in FIG. 2b is first assumed again and then the configuration depicted in FIG. 2a is assumed again.

After using assembly 1, which can be intended as part of a hedge trimmer, for example, in which case the cutting apparatus 3 is also referred to as a sword, it can be desirable to clean and/or sharpen the knives 9, 11. Particularly good accessibility of the knives 9, 11 is achieved when the two knife carriers 5, 7 are positioned relative to each other as depicted in FIGS. 2a and 2c. On the other hand, it can be desirable for the transport of the assembly 1 that the knives 9, 11 are located one above the other, which is the case with a position of the two knife carriers 5, 7 relative to each other as depicted in FIG. 2b.

Therefore, it can be predetermined in which rest position of the two possible rest positions of the first knife carrier 5 (relative to the second knife carrier 7) the first knife carrier 5 is brought to a standstill from the working movement. For this purpose, the assembly 1 can advantageously comprise a user interface or be in operative connection with one, in order to receive a user selection regarding the selected rest position.

In other words, while the first knife carrier 5 (relative to the second knife carrier 7) is moving as part of a working movement (and is thereby moving back and forth periodically between its reversal points), a braking operation is initiated in response to a command, starting from the working movement, in such a way that that the selected rest position of the first knife carrier 5 (relative to the second knife carrier 7) is approached and the first knife carrier 5 is brought to a standstill there. As a function of the selected rest position, the knives 9, 11 of the two knife carriers 5, 7 are then either one above the other (as illustrated in FIG. 2b) or offset from one another (as illustrated in FIG. 2a or 2c).

To make this possible, the assembly comprises a check apparatus 35 that is or can be operatively connected to the drive unit 17. By means of the check apparatus 35, a movement of the first and second knife carriers 5, 7 can be checked, in particular regulated and/or controlled, and thus the braking operation of the first knife carrier 5, 7 (and with it that of the second knife carrier) can be checked, in particular regulated and/or checked.

The control apparatus 35 can exchange data with the drive unit 17, in particular with the motor 19, via a data line 37 to which it can send control commands, for example for adjusting a speed at which the motor shaft 21 of the motor 19 is rotated.

The control apparatus 35 receives an operating parameter signal relating to the torque of the motor 19 via the data line. Thus, the control apparatus 35 can evaluate the operating parameter of the motor 19 and, as a function of a result of the evaluation, influence the braking operation by regulating and/or controlling the carrying out of the braking operation. Presently, the operating parameter signal is a control unit signal and is provided by a control unit of the motor 19 via the data line 37.

The control apparatus 35 therefore also comprises interfaces for receiving, among other things, the operating parameter signal and means for processing, evaluating and analyzing the operating parameter signal. The control apparatus 35 also comprises interfaces for sending control commands to the motor control unit of the motor 19.

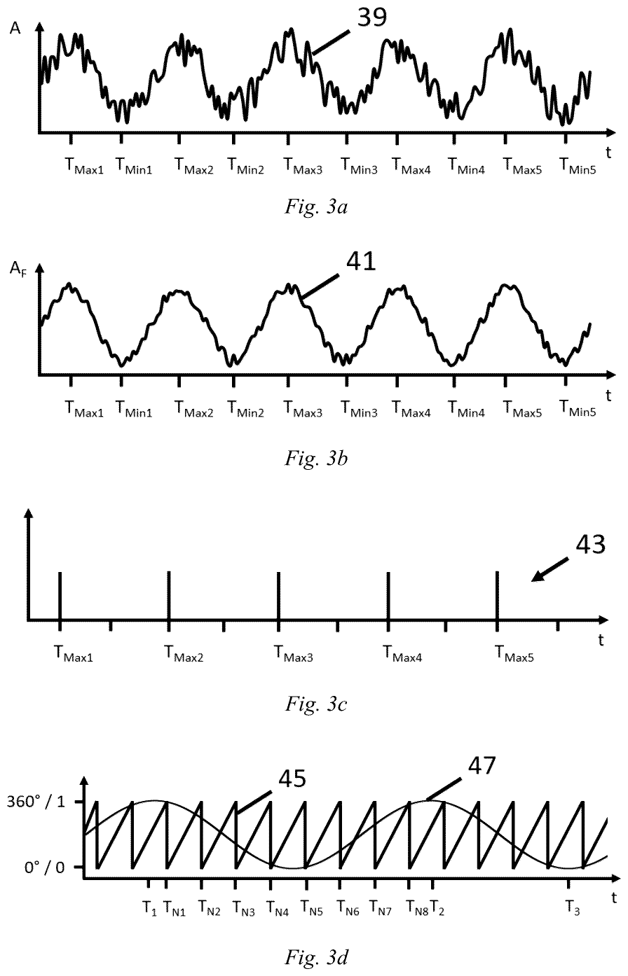

FIG. 3a shows a time course of the operating parameter signal (motor torque) 39 (ordinate axis A). FIG. 3b shows a preprocessed version of the operating parameter signal of FIG. 3a as a signal course 41 (ordinate axis AF). The signal course 41 shown in FIG. 3b can be obtained by smoothing (low-pass filtering) the raw signal course 39 shown in FIG. 3a. The signal courses 39, 41 shown in FIGS. 3a and 3b can be discrete-time.

In the preprocessed operating parameter signal 41, the maxima in the course of the preprocessed operating parameter signal 41, which occur there at the points in time TMax1 . . . TMax5, are identified as features. In FIG. 3c, the points in time TMax1 . . . TMax5 are indicated by “impulses” and thus form a feature signal 43. For faster orientation, the points in time of the maxima are also indicated on the time axis of the diagram in FIG. 3a. Alternatively. the minima that occur at the points in points in time TMin1 . . . TMin5 could also be identified as features in the preprocessed operating parameter signal 41.

A known context for the assembly 1 shown in FIG. 1 is that the motor torque has a maximum value (as at points in time TMax1 . . . TMax5 in the course of signals 39 and 41) when the first knife carrier 5 (and thus also the second knife carrier 7) is at a reversal point (as illustrated in FIG. 2a and FIG. 2c). And that the motor torque has a minimum value (as at points in time TMin1 . . . TMin5 in the course of signals 39 and 41) when the first knife carrier 5 (and thus also the second knife carrier 7 presently) is in a center position (as illustrated in FIG. 2b). Thus, defined positions of the first knife carrier (relative to the second knife carrier) can be assigned to the features identified in operating parameter signal 41. This means that the current position of the first and second knife carrier 5, 7 is known at the individual points in time TMax1 . . . TMax5 and TMin1 . . . TMin5 and the braking operation can then be carried out at least partially as a function of the determined current position.

While the motor 19 is being actuated, its motor shaft 21 is rotated about the axis of rotation of the motor 19. In doing so, a rotary encoder is used to continuously determine an angle of rotation within a range of values [0 . . . 2Π] (or [0° . . . 360°]). After a complete revolution of the motor shaft 21, the value of the positional position thus “jumps” back to zero. The positional positions determined in this way are provided as a discrete-time positional position signal and are thus available to the control apparatus 35 (via corresponding interfaces).

FIG. 3d shows a diagram with a determined correlation between a (sawtooth-shaped) time course 45 of the positional position of the motor 19 or the associated positional position signal on the one hand and a (depicted as a sine wave in an idealized manner) course 47 of the operating parameter signal (i. e. the motor torque) on the other hand during the first and second knife carriers 5, 7 each perform a working movement. The positional position of the motor 19 is, as just described, given as the relative angle of rotation of the motor shaft 21 and therefore runs in the diagram of FIG. 3d in a ramp-shaped manner from 0° to 360° and then jumps back to 0° when the motor 19 passes zero crossings, in order to rise again from there to 360° and so on. The operating parameter signal is normalized to values between 0 and 1.

It can be seen from the correlation that between two maxima of the operating parameter signal 47 (such as the maxima at points in time T1 and T2 in FIG. 3d) eight zero crossings of the motor 19 take place, corresponding to the steep edges in the positional position course 45 at points in time TN1 . . . TN8. For example, in the signal section depicted in FIG. 3d, the operating parameter signal 47 has a maximum between the 2nd and 3rd zero crossing and the next maximum between the 10th and 11th zero crossing. Accordingly, there are four zero crossings of the motor 19 between a maximum and the subsequent minimum. The number of zero crossings of the motor 19 between two consecutive maxima of the operating parameter signal 47 depends on the transmission ratio predetermined by the gear 25 and can therefore also be adjusted by selecting different the gears 23, 27 and 29.

As described above, the knives 9, 11 of the two knife carriers 5, 7 are offset from one another (as illustrated in FIG. 2a and FIG. 2c) when the motor torque signal is at its maximum, and the knives 9, 11 of the two knife carriers 5, 7 are located one above the other (as illustrated in FIG. 2b) when the signal course of the motor torque is at a minimum.

It can thus be defined for arrangement 1 as the (first) assignment that 16 motor revolutions are necessary to bring the two knife carriers 5, 7 back to the same position as they are illustrated in one of FIGS. 2a to 2c, to bring the two knife carriers 5, 7 back into this same position. Accordingly, eight motor revolutions are necessary to move the two knife carriers 5, 7 into a position as is illustrated in FIG. 2c, starting from a position of the two knife carriers 5, 7 in relation to each other as depicted in FIG. 2a. Accordingly, four motor revolutions are necessary to move the two knife carriers 5, 7 to a position as illustrated in one of the FIGS. 2b, starting from a position of the two knife carriers 5, 7 relative to each other as illustrated in one of FIGS. 2a and 2c.

Due to a defined (second) assignment, it is known that the motor shaft 21 of the motor 19 for the present arrangement 1 still carries out five revolutions between the start of the braking operation and the standstill of the first knife carrier 5.

If a braking operation is to be carried out now in such a way that, in the rest position of the first knife carrier 5, the knives 9, 11 of the two knife carriers 5, 7 are just offset to one another (FIG. 2a. 2c), a braking operation lasting five revolutions of the motor shaft 21 can be initiated against the backgrounds of the determined relationship (FIG. 3d) and the defined second assignment after identifying a maximum in the preprocessed operating parameter signal 41 with the subsequent third zero crossing of the motor 19.

Specifically, using the diagram of FIG. 3d, a maximum of the operating parameter signal 47 could be identified at the point in time T1, whereupon the two subsequent zero crossings of the motor 19 at the points in time TN1 and TN2 are awaited before the braking operation is initiated at the point in time TN3 of the third zero crossing. Then the first knife carrier 5 comes to a standstill at point in time TN8, i. e. at approximately the same point in time T2 at which the motor torque has its next maximum and therefore the knives 9, 11 of the two knife carriers 5, 7 are offset to each other.

If, on the other hand, a braking operation is to be carried out in such a way that, in the rest position of the first knife carrier 5, the knives 9, 11 of the two knife carriers 5, 7 are located precisely one above the other (FIG. 2b), the braking process can be initiated, against the background of the determined relationship (FIG. 3d) and the defined second assignment, after identifying a maximum in the preprocessed operating parameter signal 47 with the subsequent seventh zero crossing, i. e. at point in time TN7, the braking operation is initiated so that the first knife carrier 5 comes to a standstill after a further five zero crossings of the motor 19, i. e. at approximately point in time T3, when the motor torque has its next minimum and therefore the knives 9, 11 of the two knife carriers 5, 7 are located one above the other.

The braking operation is therefore carried out at least as a function of (a) the operating parameter of the drive unit 17, specifically a feature identified in the preprocessed operating parameter signal 41 in the form of a maximum, (b) the relationship between the positional position of the motor 19 and the operating parameter signal 41, and (c) the second assignment with respect to the revolutions to a standstill, by starting the braking operation with a time delay after the occurrence of a maximum in the course of the preprocessed operating parameter signal 41. Thus, the braking operation is also implicitly carried out as a function of a transmission ratio of the gearbox 25 of the drive unit 17 as a configuration parameter.

To change the rest position, instead of adjusting the number of zero crossings to be awaited, a minimum instead of a maximum of the operating parameter signal could also be identified and, starting from this, two zero crossings of the motor could be awaited (as before) before the braking operation is initiated at the point in time of the third zero crossing.

Based on the aforementioned, it is also apparent that, instead of the zero crossings, other and, in particular, several values of the angle of rotation can be used to control the braking operation. When using a finer angle of rotation resolution, it is also possible in principle to move more precisely to the target position.

The drive unit 17 can also have a completely or at least partially different structure in examples. For example, the drive unit 19 can comprise fewer or more gears than the three gears 23, 27, 29 shown in FIG. 1.

Although in the cutting apparatus 3 described with reference to FIG. 1, both the first knife carrier 5 and the second knife carrier 7 are movable and both can be set in a working movement by the drive unit 17, in examples only the first knife carrier 5 can be movable and only this can be set in a working movement by the drive unit 17. Then, the second knife carrier 7 can be intended in a fixed (immobile) manner in the cutting apparatus 3. Therefore, in the previous explanations, it always depends only on the relative movement of the first and second knife carriers 5, 7 to one another.

In each case, the drive unit 17 sets the first knife carrier 5 into a working movement relative to the second knife carrier 7, which in the scenario described above is a linear, oscillating movement.

In the previous explanations regarding the figures, the counter-element was described as a second knife carrier 7. In examples, the counter-element can also be formed as a cutting edge carrier instead of a knife carrier. In this case, 11 cutting edges can be arranged or formed on the cutting edge carrier instead of knives. The cutting edges then interact with the knives 9 of the first knife carrier 5.

The assembly 1 can be intended in a garden tool, such as a hedge trimmer. In a hedge trimmer, the cutting apparatus is also referred to as a sword. In a hedge trimmer, the first knife carrier and counter-element (i. e. a second knife carrier) are typically bar-shaped.

The assembly 1 can also be intended in rotary shears, such as those used as garden tools or as a device in landscape maintenance or in road maintenance depots. In case of rotary shears, the knife carrier and counter-element are typically disc-shaped.

The assembly 1 can also be intended in a device used in agriculture. The cutting apparatus is then advantageously designed as a finger mower (with fingers on the counter-element).

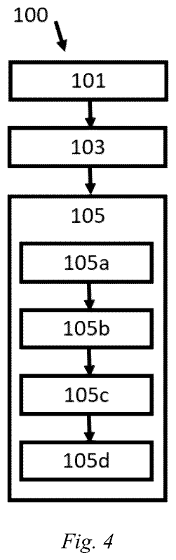

FIG. 4 shows a flow chart 100 of a method according to the first aspect of the disclosure.

In 101, a first knife carrier of a cutting apparatus is set into a working movement by means of a drive unit.

In 103, a command to initiate a braking operation is received (for example from a user interface) and/or identified.

In 105, the braking operation of at least the first knife carrier is carried out at least as a function of the torque of a motor of the drive unit, in such a way that the knives of the first knife carrier are brought to a standstill in a position offset to the knives of the counter-element in the form of a second knife carrier. In this configuration, the knives are less likely to stick together due to resin residues and other plant juices. In addition, the knives are easily accessible for cleaning in this rest position.

To carry out the braking operation in 105, an operating parameter signal of the torque is received in 105a and filtered by means of a low-pass filter. In another example, band-pass filtering can also be advantageously carried out. In 105b, the operating parameter signal that has been preprocessed in terms of signal technology is evaluated and maxima in its course are identified as features. The first maximum identified after identifying the command (in 103) is recognized as a specific feature.

Due to a previously known correlation, it is known that the motor shaft of the motor makes a certain positional position change between two successive maxima of the torque, i. e., the motor shaft of the motor thus carries out a certain number of revolutions. Due to an assignment, it is known that a certain positional position change of the motor will take place until the first knife carrier is brought to a standstill from the working movement.

In 105c, a future point in time at which the braking operation is initiated is determined as a function of the determined correlation and the assignment. In other words, the braking operation is delayed after the specific feature has been identified, still as a function of the determined correlation and the assignment. In 105d, the first knife carrier is brought to a standstill based on the working movement in the predetermined rest position.

During the execution of the method described in flow chart 100, the individual steps need not necessarily be carried out in the described order, unless the context requires otherwise.

The features disclosed in the preceding description, drawings and claims can, individually or in any combination, be essential to the disclosure in its various examples.

1. A method for carrying out a braking operation of at least a first knife carrier of a cutting apparatus, wherein the first knife carrier is set into a working movement by means of a drive unit and, in response to a command, a braking operation of at least the first knife carrier is carried out at least as a function of at least one operating parameter of the drive unit in such a way that the first knife carrier is brought to a standstill from the working movement in a predetermined rest position, wherein the at least one operating parameter is an operating parameter of a motor of the drive unit.

2. The method of claim 1, wherein the braking operation is carried out at least partially as a function of an operating parameter signal, in particular as a function of an evaluation of the operating parameter signal.

3. The method of claim 1, wherein the operating parameter signal is preprocessed, in particular by carrying out at least one smoothing, one filtering and/or one normalization of the operating parameter signal.

4. The method of claim 1, wherein in the in particular preprocessed operating parameter signal, one or more features, such as one or more characteristic curves of the operating parameter signal, one or more extreme values and/or zero crossings in the course of the operating parameter signal and/or one or more points in time, in particular at which an extreme value and/or zero crossing occurs in the operating parameter signal course, and the braking operation is carried out at least partially as a function of the identified features.

5. The method of claim 4, wherein a defined position of the first knife carrier is assigned to at least one identified feature.

6. The method of claim 1, wherein at least one positional position of the motor shaft of the motor is detected and the braking operation of the first knife carrier is carried out as a function of the at least one detected positional position.

7. The method of claim 6, wherein a correlation between a time course of the positional position of the motor shaft of the motor on the one hand and a time course of the operating parameter signal on the other hand is determined or predetermined and the braking operation is carried out as a function of the determined or predetermined correlation.

8. The method of claim 6, wherein at least one of
(i) an initial assignment is defined that describes or makes a positional position change of the motor shaft of the motor determinable, in particular a number of revolutions of the motor shaft of the motor, that is necessary to move the first knife carrier during the working movement from a specific position, in particular a position in which the first knife carrier is located in a reversal point and/or in a center position, in particular between two reversal points, to move it again to the specific position during the working movement,
(ii) a second assignment is defined which describes or makes a positional position change of the motor shaft of the motor determinable, in particular a number of revolutions of the motor shaft of the motor, which is necessary to bring the first knife carrier to a standstill during the braking operation, starting from the working movement, or
(iii) a third assignment is defined which describes or makes a positional position change of the motor shaft of the motor determinable, in particular a number of revolutions of the motor shaft of the motor, that is necessary to move the first knife carrier during the working movement from its position at the point in time of occurrence of a specific feature in the operating parameter signal to a position that corresponds to the rest position.

9. The method of claim 7, wherein the braking operation is started with a time delay after the occurrence of at least one specific feature among the features identified in the course of the operating parameter signal, the time delay being selected at least partially as a function of (i) the determined correlation, (ii) the first assignment, (iii) the second assignment and/or (iv) the third assignment, in particular selected such that the motor shaft of the motor performs a defined change in the positional position during the time delay.

10. The method of claim 2, wherein a current and/or future position of the first knife carrier is determined at least partially on based on of the, in particular preprocessed, operating parameter signal and/or at least one, in particular several, of the features identified therein, the positional position of the motor shaft of the motor, the determined correlation, the first assignment, the second assignment and/or the third assignment, and the braking operation is carried out at least partially as a function of the determined current and/or future position.

11. The method of claim 1, wherein a future point in time for initiating the braking operation and/or at least one phase thereof and/or a course of the braking operation and/or at least one phase thereof is at least partially determined based on at least one of
(i) the determined current and/or future position of the first knife carrier,
(ii) the positional position of the motor, the determined correlation, the first assignment, the second assignment and/or the third assignment,
(iii) the, in particular preprocessed, operating parameter signal and/or the features identified therein,
(iv) a predetermined or determined deceleration characteristic of the drive unit, the cutting apparatus and/or the first knife carrier, and/or
(v) an extrapolation of the operating parameter signal and/or the current position and the braking operation and/or at least one phase of the braking operation is carried out, in particular initiated, at least partially as a function of the determined future point in time and/or the determined profile.

12. An assembly, in particular for a garden tool, a device used in landscape maintenance or in road maintenance depots or for a device used in agriculture or forestry, having a cutting apparatus and a drive unit, which is or can be operatively connected to at least a first knife carrier of the cutting apparatus and by means of which the first knife carrier can be set in a working movement, the assembly comprising a control apparatus which is or can be operatively connected to at least the drive unit, the assembly being configured to carry out the method of claim 1.

13. The assembly of claim 12, wherein assembly is for the garden tool and is operable by means of a rechargeable battery and/or the assembly is formed as a hedge trimmer or as a rotary trimmer.

14. A garden tool having a cutting apparatus and a drive unit, which is or can be operatively connected to at least a first knife carrier of the cutting apparatus and by means of which the first knife carrier can be set in a working movement, the garden tool comprising a control apparatus which is or can be operatively connected to at least the drive unit, the garden tool being configured to carry out a method for a braking operation of at least the first knife carrier of the cutting apparatus, wherein the first knife carrier is set into a working movement by means of the drive unit and, in response to a command, a braking operation of at least the first knife carrier is carried out at least as a function of at least one operating parameter of the drive unit in such a way that the first knife carrier is brought to a standstill from the working movement in a predetermined rest position, wherein the at least one operating parameter is an operating parameter of a motor of the drive unit.

15. The garden tool of claim 14, wherein the garden tool is operable by means of a rechargeable battery.

16. The garden tool of claim 14, wherein the garden tool is formed as a hedge trimmer or as a rotary trimmer.
